(19) United States
(12) Patent Application Publication
(10) Pub. No.: US 2023/0059196 A1
(43) Pub. Date: Feb. 23, 2023

(54) SYSTEM AND METHOD FOR GENERATING POWER

(71) Applicant: Ian Clague, Bradford-on-Avon (GB)

(72) Inventor: Ian Clague, Bradford-on-Avon (GB)

(21) Appl. No.: 17/406,253

(22) Filed: Aug. 19, 2021

(51) Int. Cl. H02N 11/00

(52) U.S. Cl. CPC H02N 11/002

(57) ABSTRACT

Disclosed is a system (100, 500) for power generation. The system comprises a flywheel assembly (104, 200) comprising matter therein and a chamber arrangement enclosure (102) surrounding the flywheel assembly, wherein the chamber arrangement enclosure is configured to store antimatter (408) therein using magnetic and/or electrostatic fields. Herein the antimatter in the chamber arrangement enclosure is configured to cause rotation (106) of the flywheel assembly, said rotation providing a driving force to the flywheel assembly for generation of power via a turbine connected thereto.

### TECHNICAL FIELD

The present disclosure relates generally to power generation; and more specifically, to systems for generating power using antimatter stored in a chamber arrangement enclosure.

### BACKGROUND

Power generation, or electricity generation is an essential part of modern life. The global power consumption has amounted to approximately 23,398 billion kilowatt hours, or 23,398 terawatt hours in 2018. In order to generate power, various methods have been devised over the years. These methods of power generation are divided into two categories, namely, renewable power generation and non-renewable power generation. Herein, renewable power is obtained from natural resources or processes that are constantly replenished. For example, renewable power generation harnesses power from sun, wind, tidal wave and so forth. In contrary, non-renewable power generation includes power derived from coal, oil, natural gas and nuclear energy and is currently used in abundance because of accessible infrastructure and affordability.

Notably, renewable power generation may be unreliable as they are completely dependent on weather of the particular area where the renewable power generation plant is situated. Furthermore, renewable power generation suffers from low efficiency levels as there is lack of sufficient knowledge to effectively harness the natural resources for consumption. Consequently, non-renewable power generation is employed in abundance and is quite affordable. Moreover, non-renewable power generation is cost effective and easier to produce and use. However, non-renewable resources cannot be replenished. Furthermore, fossil fuels used the non-renewable resources contribute to global warming. Also, certain harmful gases are released when the fossil fuels are burned, such as nitrous oxides, sulphur dioxide, carbon dioxide and so forth. Furthermore, nitrous oxides cause photochemical pollution, sulphur dioxide creates acid rain, and greenhouse gases such as carbon dioxide cause global warming.

Therefore, in light of the foregoing discussion, there exists a need to overcome the aforementioned drawbacks associated with conventional methods for generating power.

### SUMMARY

The present disclosure seeks to provide a system for power generation. The present disclosure also seeks to provide a method for power generation. An aim of the present disclosure is to provide a solution that overcomes at least partially the problems encountered in prior art.

In one aspect, the present disclosure provides a system for power generation, the system comprising
a flywheel assembly comprising matter therein; and
a chamber arrangement enclosure surrounding the flywheel assembly, wherein the chamber arrangement enclosure is configured to store antimatter therein using magnetic and/or electrostatic fields;
   wherein the antimatter in the chamber arrangement enclosure is configured to cause rotation of the flywheel assembly, said rotation providing a driving force to the flywheel assembly for generation of power via a turbine connected thereto.

In another aspect, the present disclosure provides a method of power generation using the aforementioned system.

Embodiments of the present disclosure substantially eliminate or at least partially address the aforementioned problems in the prior art, and enable efficient generation of power.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of top view and perspective view of a system for power generation, in accordance with an embodiment of the present disclosure;

FIG. 2 is an illustration of perspective view of the flywheel assembly, in accordance with an embodiment of the present disclosure;

FIG. 3 is a schematic illustration of a tokamak ring-shaped chamber, in accordance with an embodiment of the present disclosure;

FIG. 4 is a schematic illustration of a particle accelerator arrangement, in accordance with an embodiment of the present disclosure; and

FIG. 5 is a schematic diagram of an efficient antimass generator for example for use when implementing the system of FIG. 1.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a system for power generation, the system comprising
a flywheel assembly comprising matter therein; and
a chamber arrangement enclosure surrounding the flywheel assembly, wherein the chamber arrangement enclosure is configured to store antimatter therein using magnetic and/or electrostatic fields;
   wherein the antimatter in the chamber arrangement enclosure is configured to cause rotation of the flywheel assembly, said rotation providing a driving force to the flywheel assembly for generation of power via a turbine connected thereto.

The present disclosure provides a system for power generation including a flywheel assembly and a chamber arrangement enclosure. The system as described in the present disclosure comprises antimatter in the chamber arrangement enclosure which is configured to cause rotation of the flywheel assembly, wherein the said rotation provides a driving force to the flywheel assembly for generation of power via a turbine connected thereto. The present disclosure further provides a compact and practical particle accelerator arrangement that can be used for power generation. Notably, the system described herein is suited for efficient generation of power without use of fossil fuels.

Notably, modern physics research has identified that a force of gravitational attraction between two positive masses; however, when one of the two positive masses is replaced by a corresponding antimatter mass, the antimatter mass experiences a repulsion between matter and antimatter. It is this force that is being harnessed to provide driving force to the flywheel assembly. Moreover, the strength of this repulsive gravitational force has been found to be much stronger than Newtonian gravity. This means that a relatively small amount of antimatter provides a large driving force to the flywheel assembly, which consists of positive matter. Indeed, the repulsive gravitational force has been found to be 10⁴⁵ (ten to the power 45) times more powerful than Newtonian gravity.

The system comprises a flywheel assembly comprising matter therein. Herein, the flywheel assembly comprises a flywheel, a motor-generator unit, a power converter unit, magnetic bearings and an external inductor. Furthermore, the flywheel is a matter having mass spinning about an axis. Functionally, the flywheel assembly is an energy storage device that stores mechanical energy in the form of kinetic energy before conversion to electrical energy by generator present in the motor-generator unit. Herein, the kinetic energy of the flywheel is given by

$${E}_{k} = \frac{1}{2} I {ω}^{2}$$

wherein I is the moment of inertia and ω is angular velocity of the rotating disc of the flywheel arrangement. Furthermore, the moment of inertia is given by the equation

I=∫r²dm

wherein r is radius of the rotating disc in the flywheel arrangement. In the present disclosure, the flywheel arrangement is cylindrical in structure, wherein the moment of inertia is given by

$$I = \frac{1}{2} {r}^{4} π a ρ$$

wherein α is cross-sectional area of the rotating disc in the flywheel arrangement and ρ is density of the rotating disc in the flywheel arrangement. Furthermore, the motor-generator unit in the flywheel arrangement are permanent magnet machines. Herein, the motor-generator unit exhibit low rotor losses and low winding inductance. Thereby, rapid energy transfer takes place in the flywheel assembly. Functionally, the motor-generator unit performs absorption and discharge of energy.

Additionally, the power converter unit comprises a three-phase insulated-gate bipolar transistor (IGBT) based pulse-width modulation (PWM) inverter and or rectifier. Herein, the IGBT is a solid-state device with ability to handle voltages up to 6.7 kiloVolts, currents up to 1.2 kiloAmperes and high switching frequencies. Furthermore, the magnetic bearings comprise permanent magnets and electromagnets. Herein, the permanent magnet supports weight of the flywheel by repelling forces, and electromagnets stabilizes the flywheel. The magnetic bearings may be for example, but not limited to, high temperature superconductor (HTS) magnetic bearing, active magnetic bearings (AWB). Herein, the HTS magnetic bearing can place the flywheel automatically without the need of electricity or a positioning control system. Furthermore, HTS magnetic bearing require cryogenic cooling by liquid nitrogen. Moreover, the external inductor is connected in series with the power converter unit in order to reduce total harmonic distortion (THD).

The system comprises chamber arrangement enclosure surrounding the flywheel assembly. The chamber arrangement enclosure is configured to store antimatter therein, using magnetic and/or electrostatic fields. Herein, the chamber arrangement enclosure is a vacuum chamber to reduce friction and energy losses.

Optionally, a weight of the matter in the flywheel assembly corresponds to a negative weight of the antimatter in the chamber arrangement enclosure. Herein, matter and antimatter pairs briefly orient themselves in relation to the mass of the flywheel assembly. Furthermore, flywheel assembly comprises matter which is attracted to the negative weight of the antimatter. Conversely, the chamber arrangement enclosure comprises antimatter which is repelled by the weight of the matter. Thereafter, a negative pressure is created to produce accelerated motion of rotor in the flywheel assembly.

Optionally, the chamber arrangement enclosure is configured to store antimatter therein, for example positrons therein, by using magnetic and/or electrostatic fields. Herein, the term “positron” refers to antimatter part of the electron having an electric charge of +1 e and a spin of ½. It will be appreciated that when antimatter is contacted by electrons or matter particles, annihilation occurs generating two photons. Therefore, positrons are to be generated in vacuum conditions and suspended in the chamber arrangement enclosure using magnetic and/or electrostatic fields in a manner that positrons are not contacted by any matter.

Optionally, the chamber arrangement enclosure is implemented as a tokamak ring-shaped chamber that is configured to store the antimatter along an annular central magnetic axis of the tokamak ring-shaped chamber. Notably, the tokamak ring-shaped chamber is shaped in the form of a ring or a torus, wherein toroidal field coils are helically wound around the torus to induce a magnetic field along the annular central magnetic axis thereof. Additionally, or alternatively, optionally, the tokamak ring-shaped chamber employs permanent neodymium magnets to suspend the antimatter in the chamber arrangement enclosure. The tokamak ring-shaped chamber provides a high-vacuum (for example, at a vacuum pressure of less than 1×10⁻⁷ milliBar, more optionally less than 1×10⁻⁹ milliBar, achievable using a combination of a roughing pump and a vacuum turbo pump), hermetically sealed chamber for the antimatter, wherein the antimatter continuously spirals around the annular central magnetic axis without touching the walls.

Optionally, the system further comprises a laser arrangement, a target that is configured to be stimulated by a laser beam generated by the laser arrangement to produce the antimatter, and a deflector arrangement that is configured to guide the antimatter generated at the target into the chamber arrangement. Notably, the laser beam generated by the laser arrangement is directed towards the target, wherein the laser beam ionizes and accelerates electrons, which are driven through the target. Optionally, the laser beam may be a pulsed laser beam or a laser beam having a high intensity. Herein, as the electrons are driven through the target, the electrons interact with nuclei of the target, wherein the nuclei serve as a catalyst to create antimatter. The electrons emit packets of energy, wherein the energy decays into matter and antimatter, following the predictions by Einstein's equation relating to matter and energy (E=mc²). Notably, by concentrating the energy in space and time, the laser beam produces antimatter in a high density. The target may have a thickness in an order of a few millimetres and may be manufactured using Gold Erbium or Tantalum, for example. As the antimatter is generated, the deflector arrangement guides the antimatter into the chamber arrangement enclosure. Optionally, the target is spatially integrated with the tokamak ring-shaped chamber.

In an embodiment, the target further comprises a composite Copper-Gold, Copper-Erbium or Copper-Tantalum structure that is irritated with pulsed laser beams, wherein the composites upon irradiation generate intense laser beams that subsequently excite the Gold, Erbium or Tantalum target to generate antimatter.

Optionally, the target is provided with one or more fluid channels for accommodating a flow of a cooling fluid therethrough for cooling the target. More optionally, the target may be a Gold sheet, an Erbium sheet or a Tantalum sheet that is bonded to a heat sink, wherein the heat sink includes internal fluid channels therein for accommodating a flow of a cooling fluid for cooling the heat sink and its Gold, Erbium or Tantalum sheet. It will be appreciated that when blasted with accelerated particles or laser beams, the target may reach a high temperature, unless cooled by using a cooling fluid as aforementioned. The one or more internal fluid channels for accommodating a flow of cooling fluid reduces an operating temperature of the target, thereby enabling a safe operation thereof.

Optionally, the target is raster scanned by a laser beam or high-energy particle beam over its entire area rather than being maintained on just one area of the target. Beneficially, such raster scanning ensure that thermal dissipation occurs over the entire area of the target, thereby avoiding localized sputtering, evaporation or ablation of the target. This can be achieved by scanning the laser beam or actuating the target, or a mixture of both.

Optionally, the laser arrangement includes one or more Q-switched lasers that are configured to generate light pulses that cause the antimatter to be generated in the target. Notably, the Q-switched laser produces light pulses of high peak power, specifically in an order of gigawatts. The light pulses produced by the one or more Q-switched lasers generally produce light pulses that last a few nanoseconds. Such short operational time allows greater control over the generation of antimatter at the target. It will be appreciated that a Q-switched laser of high intensity may generate a high ratio of antimatter to electrons, possibly approaching a neutral “pair plasma” with equal numbers of antimatter and electrons.

Optionally, the system further comprises a particle accelerator arrangement, a target that is configured to be stimulated by a particle beam generated by the particle accelerator arrangement to produce the antimatter, and a deflector arrangement that is configured to decelerate and guide the antimatter generated at the target into the chamber arrangement enclosure. Herein, a miniaturized version of particle accelerator arrangement is used for the production of antimatter. Notably, the particle accelerator arrangement uses electromagnetic fields to propel charged particles, such as protons or electrons, to very high speeds and energies, and to contain them in well-defined beams. Subsequently, the charged particles are either smashed onto a target or against other particles circulating in an opposite direction, thereby generating beams of electrons, antimatter, protons, and antiprotons interacting with each other or with the simplest nuclei at the highest possible energies, generally hundreds of GeV or more. As the antimatter is generated, the deflector arrangement decelerates and guides the antimatter into the chamber arrangement enclosure. It will be appreciated that electrons are decelerated and guided into the chamber arrangement enclosure in high-vacuum conditions, wherein the target, the deflection arrangement and the interior of the chamber arrangement enclosure needs to be evacuated of air when the particle accelerator arrangement is in operation (for example, a vacuum to 1×10⁻⁸ milliBar is required).

Optionally, the deflector arrangement includes one or more electromagnetic and/or electrostatic lenses for focusing the antimatter generated at the target as an antimatter beam to feed into the chamber arrangement. Notably, the deflector arrangement ensures that the antimatter generated at the target do not contact any matter and are focused as an antimatter beam into the chamber arrangement enclosure to be suspended therein using magnetic and/or electrostatic fields. The electromagnetic lens used herein may be similar in its operation to electromagnetic lenses as used in a conventional scanning electron microscope (SEM). Furthermore, the deflector arrangement is maintained at a potential difference in comparison with the target to draw antimatter away from the target and into the chamber arrangement enclosure. Additionally, optionally, the deflector arrangement may employ permanent neodymium magnets for focusing the antimatter into the chamber arrangement enclosure.

In an embodiment, laser pincers may be used for the production of antimatter. Herein, the laser pincers comprise a first laser and a second laser opposite to the first laser. Furthermore, the first laser and the second laser are fired from the laser pincers at a plastic block. Furthermore, the plastic block comprises crisscrossed channels, wherein the crisscrossed channels are micrometers wide. Subsequently, the crisscrossed channels help to accelerate a cloud of electrons within the plastic block once the first laser and the second laser have shot through the plastic block. Consequently, upon collision of the cloud of electrons from the first laser and the second laser, a large number of gamma rays are produced which produces matter and antimatter. Additionally, the laser pincers utilize magnetic fields to concentrate the antimatter into a focused beam. Consequently, over a distance of at most 50 micrometers, the focused beam may reach an energy of 1 gigaelectronvolt.

In an embodiment, the chamber arrangement enclosure is implemented as a stellarator that is configured to store the antimatter therein. Notably, the stellarator is a device that employs external magnets to confine antimatter therein.

In an embodiment, the chamber arrangement enclosure is implemented as a buffer-gas trap comprising a Penning-Malmberg type electromagnetic trap to store antimatter therein. It will be appreciated that magnetic fields required for operating the chamber arrangement enclosure need to be of considerable strength since the magnetic fields will effectively bear a weight of the vehicle. The buffer-gas trap, is a type of ion-trap that provides an axial electric charge which prevents the positively charged positrons from escaping radially. Specifically, antimatter is confined in a vacuum inside an electrode structure consisting of a stack of hollow, cylindrical metal electrodes. A uniform axial magnetic field inhibits positron motion radially, and voltages imposed on end electrodes prevent axial loss.

Optionally, the target, for example, a Gold, Erbium or Tantalum target is spatially integrated with the buffer-gas trap. Notably, the antimatter generated at the target are consequently transferred to the buffer-gas trap for storage. Beneficially, the buffer-gas trap is a compact and light-weight implementation of the chamber arrangement enclosure and can be used to generate power. Furthermore, the buffer-gas trap slows down an antimatter beam to electron-volt energies and accumulates them in the trap.

Pursuant to the embodiments describing the buffer-gas trap, the present disclosure employs a modified Penning-Malmberg trap as the buffer-gas trap that comprises of a series of cylindrically symmetric electrodes of varying inner diameters. These form three distinct trapping stages with three distinct pressure regions, and confine the antimatter axially by producing electrostatic potentials. The antimatter is confined radially by a static magnetic field produced by one solenoid enclosing the electrodes. The principle of this trap is that the incoming antimatter lose their energy through inelastic collisions with a buffer gas that is introduced in the first stage of the trap. As they cool down, they become trapped in successively deeper potential wells, and progressively lower pressure, until the antimatter is confined on the lowest pressure region of the trap, where the lifetime is longer. It is to be noted that in order to trap the antimatter with a few tens of electron-volt energy, they must lose enough energy so that they do not exit the trap once they are reflected by the end potential barrier. The cooling mechanism employed in this type of traps is the inelastic collisions an antimatter undergoes with the buffer gas.

The chamber arrangement enclosure comprises the antimatter which is configured to cause rotation of the flywheel assembly. Furthermore, the rotation provides a driving force to the flywheel assembly for generation of power via a turbine connected thereto. Herein, antimatter present in the chamber arrangement enclosure repels the flywheel assembly comprising matter. Thereafter, the repulsion causes the flywheel assembly to rotate. Subsequently, the rotation of the flywheel assembly is transferred to the turbine. Herein, the turbine is a generator which comprises a rotor. Thereby, the rotor starts rotating with the same speed as the rotation of the flywheel assembly. Consequently, in accordance with the principle of electromagnetic induction, current starts flowing in the rotor of the turbine. Therefore, power is generated by converting kinetic energy of the flywheel assembly to electrical energy.

The present disclosure also relates to the method as described above. Various embodiments and variants disclosed above apply mutatis mutandis to the method.

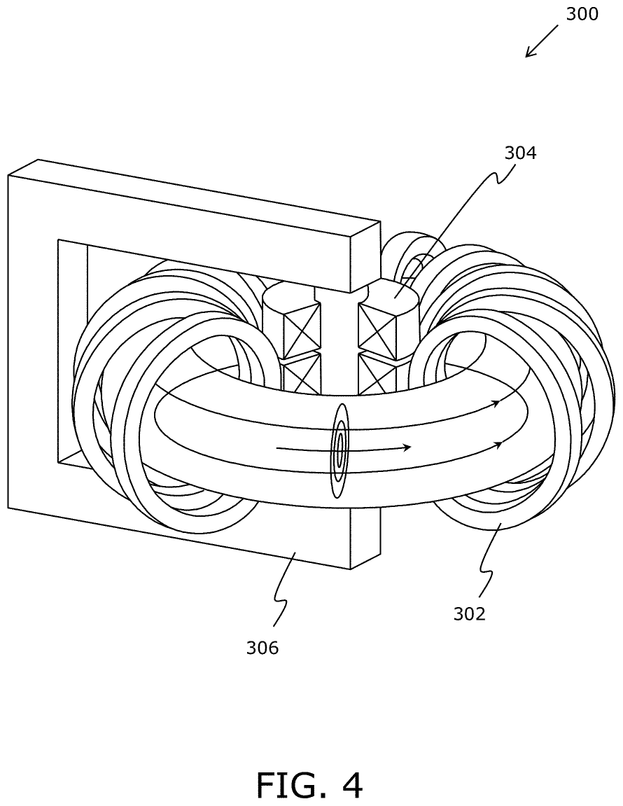

The present disclosure further provides a particle accelerator arrangement as described in detail in FIG. 4.

### DETAILED DESCRIPTION OF THE DRAWINGS

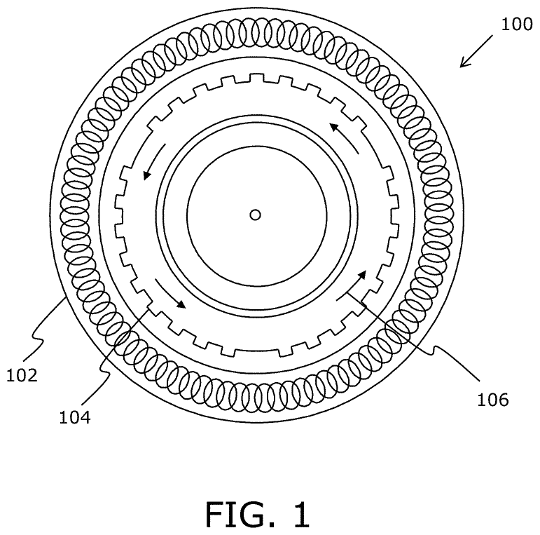

Referring to FIGS. 1A and 1B collectively, illustrated is a top view and perspective view of a system 100 for power generation, in accordance with an embodiment of the present disclosure. Herein, a chamber arrangement enclosure 102 comprises antimatter. A flywheel assembly 104 comprising matter is propelled by the antimatter present in the chamber arrangement enclosure 102 and starts rotation 106.

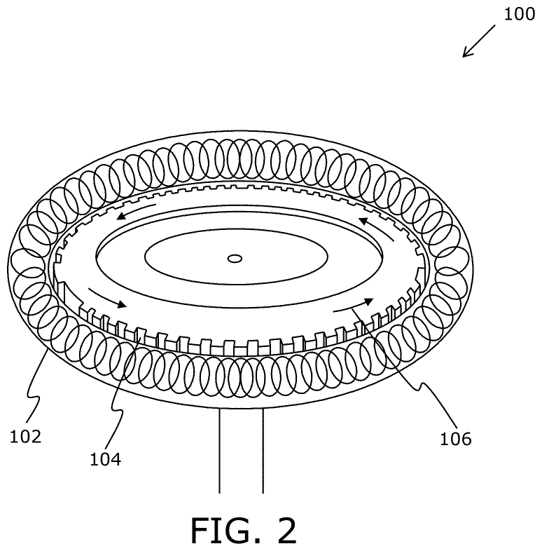

Referring to FIG. 2, illustrated is a perspective view of the flywheel assembly 200, in accordance with an embodiment of the present disclosure. The flywheel assembly 200 comprises a flywheel 202. The flywheel 202 is made of addendum 204 and dedendum 206.

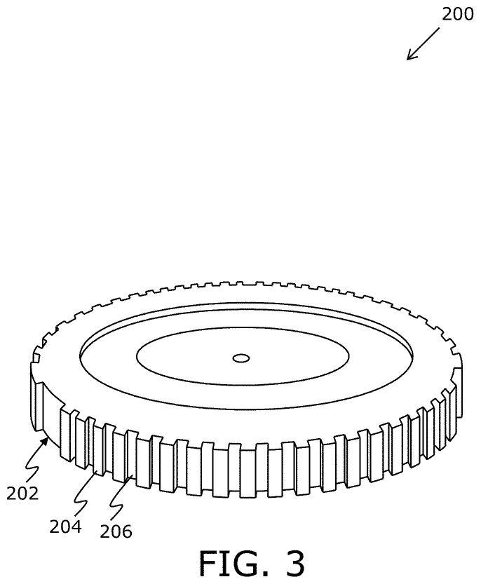

Referring to FIG. 3, there is shown a schematic illustration of a tokamak ring-shaped chamber 300, in accordance with an embodiment of the present disclosure. As shown in FIG. 3, the tokamak ring-shaped chamber 300 is shaped in the form of a ring or a torus, wherein toroidal field coils 302 are helically wound around the torus to induce a magnetic field along the annular central magnetic axis thereof. The tokamak ring-shaped chamber 300 further comprises a primary winding 304 and a transformer yoke 306.

Referring to FIG. 4, there is shown a schematic illustration of a particle accelerator arrangement 400, in accordance with an embodiment of the present disclosure. The particle accelerator arrangement 400 comprises a laser arrangement 402, a target 404 that is configured to be stimulated by a laser beam 406 generated by the laser arrangement to produce the antimatter 408, and a deflector arrangement that is configured to guide the antimatter 408 generated at the target 404 into the chamber arrangement, such as the tokamak ring-shaped chamber 410. The laser arrangement 402 includes one or more Q-switched lasers that are configured to generate light pulses that cause the antimatter 408 to be generated in the target 404. The target 404 may be manufactured using Gold, Erbium or Tantalum, although other heavy elements can alternatively be used.

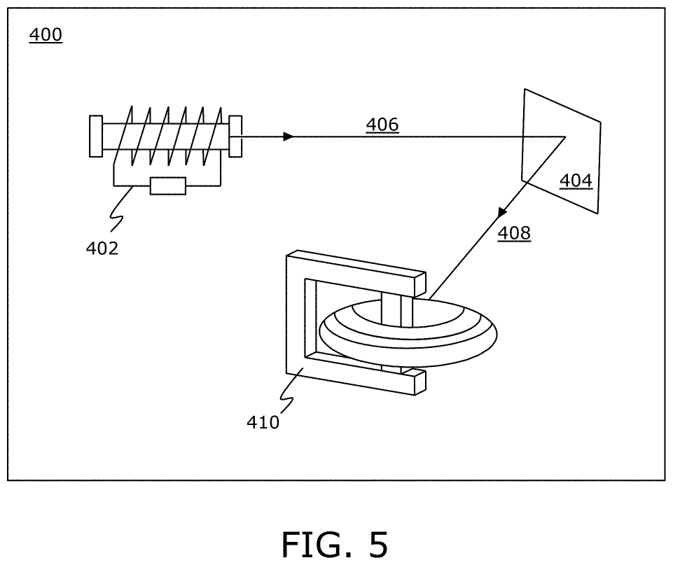

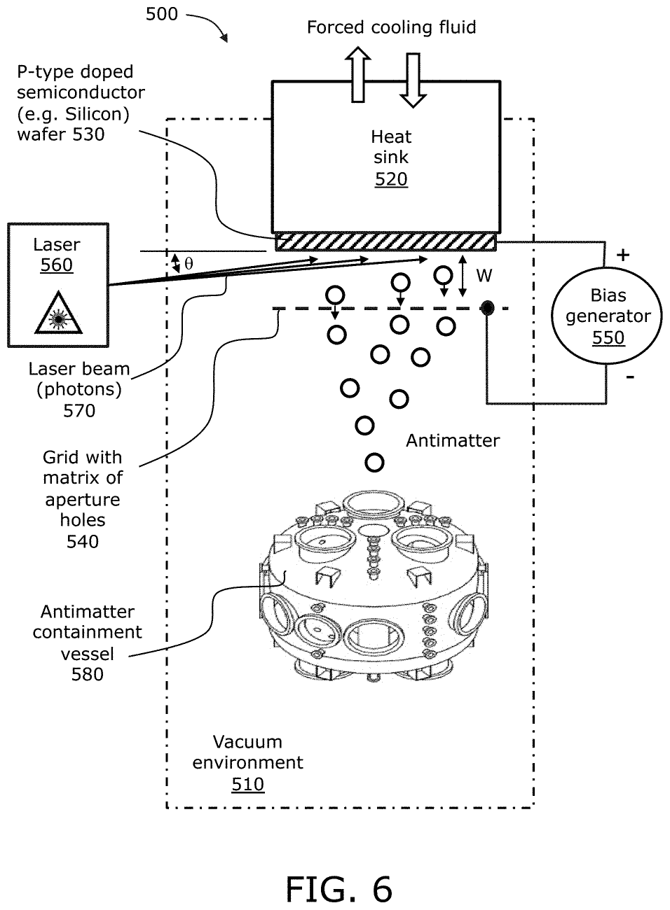

In the foregoing, it will be appreciated that being able to generate antimatter efficiently is an important performance characteristic in embodiments of the present disclosure. In FIG. 5, there is shown a particularly efficient apparatus for generating antimatter, for example for use in the power generation 100, but not limited thereto; the system is indicated generally by 500. The system 500 includes a chamber arrangement enclosure in which a vacuum environment 510 is established when the system 500 is in operation. A vacuum of at least 1×10⁻⁷ milliBar, more optionally 1×10⁻⁹ milliBar is maintained in the vacuum environment 510 by using a combination of one or more roughing pumps and one or more turbo pumps. The vacuum environment 510 houses a heatsink arrangement 520 onto which a semiconductor wafer 530, for example a Silicon wafer, is mounted; the semiconductor wafer 530 is beneficially p-doped Silicon, for example an exposed polished surface of the semiconductor wafer 530 has been ion-implanted or thermally diffused with p-type dopant, for example Boron. Optionally, the semiconductor wafer 530 is of form that is customarily used in Silicon integrated circuit manufacture. The heatsink arrangement 520 is provided with forced fluid cooling fluid to remove heat from the heatsink arrangement 520 received from the semiconductor wafer 530 when the system 500 is in operation. The vacuum environment 510 also includes a grid 540, for example implemented as a metallic mesh with an array of apertures formed therein, that is mounted so that its plane is spatially separated from a plane of the polished surface of the semiconductor wafer 530 by a distance W. Optionally, the grid 540 is fabricated from a metal having a high melting point, for example from Tungsten metal; optionally, the grid 540 is manufactured using electroplating techniques to deposit Tungsten onto a copper substrate, or by using laser cutting ablation to cut apertures into a Tungsten sheet. Although Tungsten is mentioned as a preferred metal to use for manufacturing the grid 540, it will be appreciated that other metals can be alternatively used. The distance W is beneficially in a range of 2 mm to 20 mm. A bias generator 550 is connected between the semiconductor wafer 530 and the grid 540 to maintain the grid 540 at a negative potential relative to the semiconductor wafer 530; an electric field is thereby established at the polished surface of the semiconductor wafer 530 when the system 500 is in operation. The electric field beneficially has an electric field strength E in a range of 0.3 to 1.5 MegaVolts/metre, namely in a range of 0.3 to 1.5 kiloVolts/millimetre. The bias generator 550 is conveniently implemented as a solid-state high-frequency inverter with Wheatstone bridge voltage multiplication at its output. A pulsed laser arrangement 560, for example implemented in a manner of the aforesaid laser arrangement 402, is configured to direct a pulsed laser beam 570 at a shallow angle θ, for example less than 10° relative to a plane of the polished surface of the semiconductor wafer 530, towards the polished surface of the semiconductor wafer 530; thus, the pulsed laser beam 570 is directed at the polished surface of the semiconductor wafer 530 in a region between the polished surface and the grid 540. Optionally, the laser beam 570 propagates as an evanescent wave along the polished surface of the semiconductor wafer 530 such that photon energy of the laser beam 570 is tightly bound to the polished surface of the semiconductor wafer 530; such evanescent wave propagation requires the glancing angle θ to be a very shallow glancing angle of the laser beam 570 relative to the polished surface of the semiconductor wafer 530, for example at a glancing angle of 1° or less. Optionally, peripheral edges of the semiconductor wafer 530 are polished and mutually parallel so that an optical cavity is formed at the surface of the semiconductor wafer 530 in respect of evanescent light propagation along the surface of the semiconductor wafer 530; such a configuration is particularly efficient at using photons of the laser beam 570 for generating antimatter as very light of the laser beam 570 becomes dissipated at edges of the semiconductor wafer 530. The optical cavity can be formed by scribing and cleaving the semiconductor wafer 510, and then carefully polishing to optical finish cleaved edges of the semiconductor wafer 530. An antimatter containment vessel 580, for example implemented as the aforementioned chamber arrangement enclosure 102, is positioned within the vacuum environment 510 to receive antimatter that have been generated at the polished surface of the semiconductor wafer 530 and that have been drawn away from the semiconductor wafer 530 by the aforesaid electric field and have passed through the apertures of the grid 540.

Next, a method of operating the system 500 will be described. The method includes using the aforesaid one or more roughing pumps and one or more turbo pumps to establish a vacuum in the vacuum environment 510 as described in the foregoing. Moreover, the method includes configuring the bias generator 550 to apply a potential difference between the grid 540 the semiconductor wafer 530, wherein the grid 540 is biased to a negative potential relative to the semiconductor wafer 530. Furthermore, the method includes using the pulsed laser arrangement 560 to generate the laser beam 570; as aforementioned, photons of the laser beam 570 are composite couplets, namely a combination of an electron and an antimatter. The method further includes propagating the laser beam 570 along the polished surface of the semiconductor wafer 530, wherein the photons at least partially impinge into the semiconductor wafer 530, for example by a few nanometres or even micrometres. Electrons of the photons interact with holes provided by p-type doping of the semiconductor wafer 530, wherein the electrons become preferentially absorbed into the semiconductor wafer 540, thereby allowing their corresponding antimatter to be extracted by action of the aforesaid electric field established by the bias generator 550 between the semiconductor wafer 530 and the grid 540. The semiconductor wafer 530 optionally has a p-type doping, for example Boron doping; the p-type doping concentration is selected to provide a sheet resistance at the polished surface of the semiconductor wafer 530 in a range of 0.001˜0.005 Ω-cm, optionally 0.01˜0.09 Ω-cm, optionally 0.1˜0.9 Ω-cm, optionally 1˜10 Ω-cm, and yet more optionally 20˜100 Ω-cm. Higher doping concentrations than aforesaid are optionally used when fabricating the semiconductor wafer 530. The antimatter is accelerated towards the grid 540 and a subset thereof pass through the apertures of the grid 540 to propagate to the antimatter containment vessel 580 for storage therein.

It will be appreciated that, in a known type of Silicon photovoltaic cell, for example a well-known roof-mounted photovoltaic panel, photons are received at a p-n junction of the photocell, resulting in the electrons and antimatter of the photons being preferentially absorbed in p-type and n-type regions of the photocell, respectively, thereby giving rise to an output current from the photocell.

The system 500 is exceptionally efficient for producing antimatter, and the system 500 avoids a need to decelerate high-energy antimatter particles that arise when accelerator-driven antimatter generators are employed to generate antimatter.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for power generation, the system comprising
a flywheel assembly comprising matter therein; and
a chamber arrangement enclosure surrounding the flywheel assembly, wherein the chamber arrangement enclosure is configured to store antimatter therein using magnetic and/or electrostatic fields;
wherein the antimatter in the chamber arrangement enclosure is configured to cause rotation of the flywheel assembly, said rotation providing a driving force to the flywheel assembly for generation of power via a turbine connected thereto.

2. A system of claim 1, wherein a weight of the matter in the flywheel assembly corresponds to a negative weight of the antimatter in the chamber arrangement enclosure.

3. A system of claim 1, wherein the antimatter comprises positrons.

4. A system of claim 1, wherein the chamber arrangement enclosure is implemented as a tokamak ring-shaped chamber that is configured to store the antimatter along an annular central magnetic axis of the tokamak ring-shaped chamber.

5. A system of claim 1, wherein the system further comprises a laser arrangement, a target that is configured to be stimulated by a laser beam generated by the laser arrangement to produce the antimatter, and a deflector arrangement that is configured to guide the antimatter generated at the target into the chamber arrangement.

6. A system of claim 5, wherein the laser arrangement includes one or more Q-switched lasers that are configured to generate light pulses that cause the antimatter to be generated in the target.

7. A system of claim 1, wherein the system further comprises a particle accelerator arrangement, a target that is configured to be stimulated by a particle beam generated by the particle accelerator arrangement to produce the antimatter, and a deflector arrangement that is configured to guide the antimatter generated at the target into the chamber arrangement enclosure.

8. A system of claim 1, wherein the deflector arrangement includes one or more electromagnetic and/or electrostatic lenses for focusing the antimatter generated at the target as an antimatter beam to feed into the chamber arrangement enclosure.

9. A method of power generation using the system of claim 1.
